(19) United States
(12) Patent Application Publication
(10) Pub. No.: US 2006/0181325 A1
(43) Pub. Date: Aug. 17, 2006

(54) System and method for providing on-chip clock generation verification using an external clock

(75) Inventors: Norman Karl James, Liberty Hill, TX (US); Brian Chan Monwai, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/055,824

(22) Filed: Feb. 11, 2005

(51) Int. Cl. G06F 1/04

(52) U.S. Cl. 327/291

(57) ABSTRACT

A system and method for performing functional verification of a device, and in particular a technique for performing phase-locked loop (PLL) functional verification by the device which contains the PLL circuitry. A relatively slow-speed external clock is provided to the device, and is used to generate control signals to a counter. PLL circuitry within the device generates a relatively high-speed master clock signal for use by the device. This master clock signal is coupled to a clock input of the counter, the counter having various control inputs that are used to selectively count clock pulses of the master clock. As the frequency of the external clock signal is known, and the master clock signal is generated from known PLL circuitry, it is possible to analyze the count value from the counter to determine whether the PLL circuitry used to generate the master clock is operating properly.

### BACKGROUND OF THE INVENTION

1. Technical Field

The present invention is directed to a technique for performing functional verification of a device, and in particular is directed to a self-verification technique for performing on-chip or internal device clock generation verification by the chip/device which contains the clock generation circuitry.

2. Description of Related Art

Boundary scan is a methodology allowing controllability and observability of the boundary pins of a JTAG compatible device via software control. This capability enables in-circuit testing without the need of bed-of-nail in-circuit test equipment. Certain boundary scan techniques are known, such as those described in the IEEE 1149.1 Specification known as IEEE Standard Test Access Port and Boundary Scan Architecture (which is hereby incorporated by reference as background material). Included in such a boundary scan methodology are certain data and control signals including scan-in and scan-out data signals and a scan clock control signal.

Many types of integrated circuit devices such as microprocessors use phase-locked loop (PLL) circuitry to multiply a reference clock and achieve a high frequency clock for use by the microprocessor's transistor logic. In new transistor technologies, PLL yield and reliability may often be suspect. Verifying the output of the PLL (i.e. the internally generated clock signal) typically requires a probe and oscilloscope, or complex timebase logic that requires a separate timebase clock. However, once the microprocessor or other device (having the internal PLL circuitry) is placed in a system, external probes may be difficult to connect. In addition, because of pin restrictions, the PLL output may not be brought out to a pin of the integrated circuit device (the integrated circuit device also being known as a ‘chip’). In a bring-up system, the timebase clock may not exist and the timebase logic may not be functional.

It would thus be desirable to provide an on-chip ability to verify PLL functionality with the aid of existing on-chip circuitry and associated clock signals such as a JTAG scan clock control signal.

### SUMMARY OF THE INVENTION

The present invention provides a system and method for performing functional verification of a device, and in particular a technique for performing phase-locked loop (PLL) functional verification by the device which contains the PLL circuitry. A relatively slow-speed external clock is provided to the device, and is used to generate control signals to a counter. PLL circuitry within the device generates a relatively high-speed master clock signal for use by the device. This master clock signal is coupled to a clock input of the counter, the counter having various control inputs that are used to selectively count clock pulses of the master clock. As the frequency of the external clock signal is known, and the master clock signal is generated from known PLL circuitry, it is possible to analyze the count value from the counter to determine whether the PLL circuitry used to generate the master clock is operating properly.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a circuit for generating a clock edge detect control signal.

FIG. 2 depicts a circuit for generating a measure request edge detect control signal.

FIG. 3 depicts a circuit for generating a count control signal.

FIG. 4 depicts a timing diagram of various control signals used to verify functionality of a phase-locked loop (PLL) circuit.

FIG. 5 depicts a counter being controlled to assist in verifying functionality of a phase-locked loop (PLL) circuit.

FIG. 6 depicts a phase-locked loop (PLL) circuit.

### DETAILED DESCRIPTION OF THE PREFERRED EMBODIMENT

Because boundary scan techniques such as JTAG boundary scan are well known to those of ordinary skill in the art, the details of boundary scan will not be described herein in order to maintain focus on the techniques of the present invention. Suffice it to say that the JTAG boundary scan definition includes a boundary scan clock sometimes called TCK. The present invention makes use of such boundary scan clock in performing a phase-locked loop (PLL) on-chip verification.

A phase-locked loop circuit typically uses a reference clock as an input, and through the use of circuitry used to couple the output of the PLL to the input in a feedback path, it is possible to create an output PLL clock signal that is of a higher frequency than the input reference clock frequency. Such a technique is shown at 600 in FIG. 6. There, a reference clock 602, such as from a crystal oscillator, is provided to an input of a phase detector 604. The output of the phase detector is coupled to the input of charge pump 606. The output of charge pump 606 is coupled to the input of low pass filter 608. The output of low pass filter 608 is coupled to the input of voltage controlled oscillator (VCO) 610, and the output of the VCO 610 is the PLL output clock signal 612. The output of VCO 610 is also used in a feed-back loop to provide a clock-multiplication effect of the PLL. Specifically, the output of VCO 610 is coupled to the input of a divide-by-N circuit 614. The output of divide-by-N circuit 614 is coupled to another input 616 of phase detector 604, thus completing the PLL control feed-back path. This is a representative example of a phase-locked loop clock generation circuitry for which the present invention provides on-chip verification.

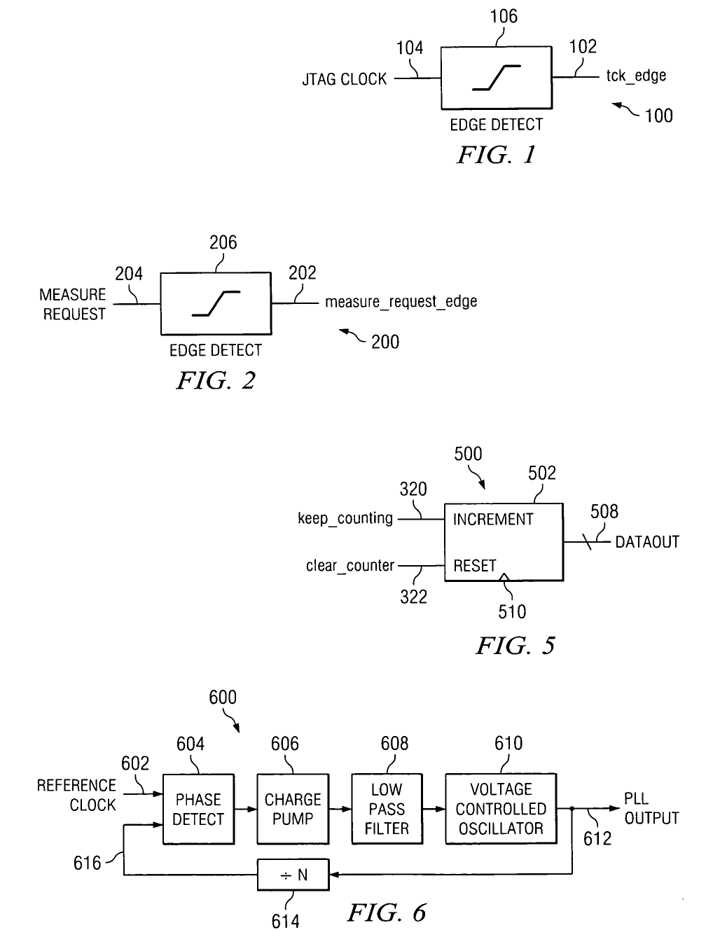

The generation of various control signals used by the present design will now be described. Referring first to FIG. 1, there is shown at 100 a technique for generating a TCK_EDGE control signal 102 from an externally provided JTAG CLOCK signal 104 using an edge detect circuit 106. This JTAG CLOCK signal is also known as a JTAG scan clock.

Referring next to FIG. 2, there is shown at 200 a technique for generating a MEASURE_REQUEST_EDGE control signal 202 from a MEASURE REQUEST control signal 204 using an edge detect circuit 206. This MEASURE REQUEST control signal 204 is generated internal to the integrated circuit device, for example by an embedded controller or processor, and signals a desire to measure the PLL output clock signal.

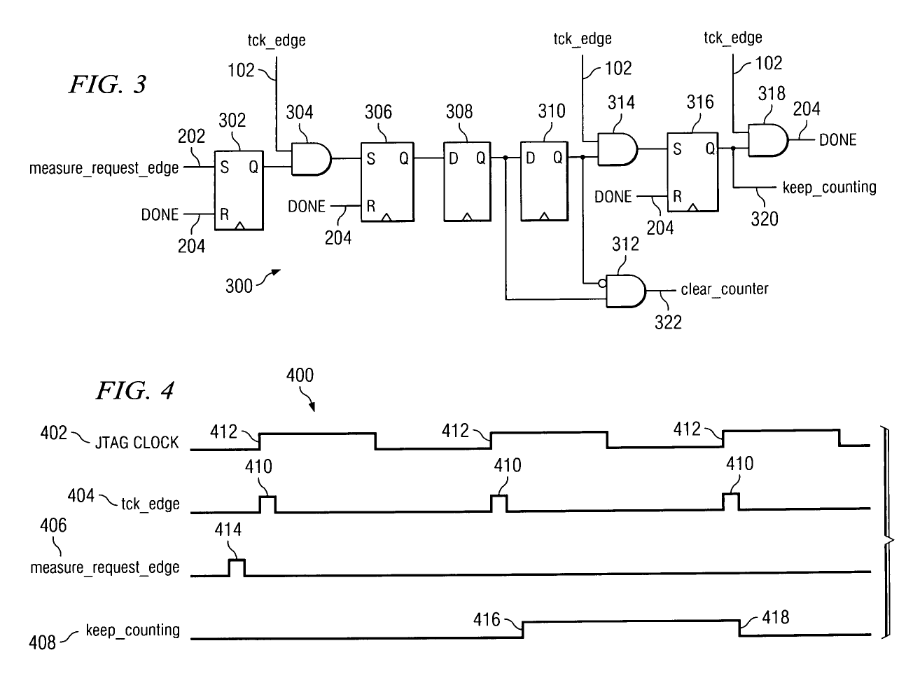

Referring now to FIG. 3, a circuit 300 is shown for generating various control signals, including the CLEAR_COUNTER and KEEP_COUNTING control signals which are used to verify PLL functionality as will be further described below. This circuitry 300 makes use of the previously described control signals TCK_EDGE and MEASURE_REQUEST_EDGE, shown in FIG. 3 at 102 and 202, respectively. An S-R flip flop 302 has at its S-input the MEASURE_REQUEST_EDGE control signal 202, and has at its R-input a DONE control signal 204. The Q-output from S-R flip flop 302 is coupled to AND gate 304. Coupled to another input of AND gate 304 is the TCK_EDGE control signal 102. The output of AND gate 304 is coupled to the S-input of S-R flip flop 306. The DONE control signal 204 is also coupled to the R-input of S-R flip flop 306. The Q-output of S-R flip flop 306 is coupled to the D-input of D flip flop 308. The Q-output of D flip flop 308 is coupled to the D-input of D flip flop 310. The Q-output of D flip flop 308 is also coupled to a non-inverted input of AND gate 312. The Q-output of D flip flop 310 is coupled to an inverted input of AND gate 312, and the output of this AND gate 312 is the generated control signal CLEAR_COUNTER 322 (to be further described below). The Q-output of D flip flop 310 is also coupled to an input of AND gate 314. Coupled to another input of AND gate 314 is the TCK_EDGE control signal 102. The output of AND gate 314 is coupled to the S-input of S-R flip flop 316. Coupled to the R-input of S-R flip flop 316 is the DONE control signal 204. The Q-output of S-R flip flop 316 is the generated control signal KEEP_COUNTING 320 (to be further described below). The Q-output of S-R flip flop 316 is also coupled to AND gate 318. Control signal TCK_EDGE 102 is coupled to another input of AND gate 318, and the output of AND gate 318 is the DONE control signal 204 previously described as being used as the signal coupled to the R-input of various S-R flip flops such as 302, 306 and 316. Certain operational aspects of this circuit 300 will now be described with reference to the timing diagram 400 shown in FIG. 4.

Referring now to timing diagram 400 of FIG. 4, there is shown the timing relationship of four control signals JTAG CLOCK 402, TCK_EDGE 404, MEASURE_REQUEST_EDGE 406, and KEEP_COUNTING 408. These correspond to the respective signals shown at JTAG CLOCK 104 of FIG. 1, TCK_EDGE 102 of FIG. 1, MEASURE_REQUEST_EDGE 202 of FIG. 2, and KEEP_COUNTING 320 of FIG. 3. As can be seen, the TCK_EDGE control signal 404 provides a pulse 410 responsive to the JTAG CLOCK signal 402 transitioning from a logic ‘0’ to a logic ‘1’ at 412, in effect providing an edge detect control signal based upon JTAG CLOCK signal 402 having a ‘0’to ‘1’ edge transition (of course, an alternate embodiment could reverse all logic control signals and use a logic ‘0’ as the active logic control state). The KEEP_COUNTING control signal 408 is shown to go from a logic ‘0’ to a logic ‘1’ at 416, and to go from a logic ‘1’ to a logic ‘0’ at 418. The transition of KEEP_COUNTING from ‘0’ to ‘1’ is responsive to a second successive TCK_EDGE pulse, and is the result of the TCK_EDGE control signal being coupled to both S-R flip flop 306 by way of AND gate 304 and S-R flip flop 316 by way of AND gate 314 (FIG. 3). Similarly, the transition of KEEP_COUNTING from ‘1’ to ‘0’ is responsive to the TCK_EDGE control signal 102 being coupled to S-R flip flop 318 (FIG. 3), which results in the DONE signal 204 going active which resets all the S-R flip flops 302, 306 and 316 and thus disables the KEEP_COUNTING control signal 320. The use of the KEEP_COUNTING control signal as a part of PLL on-chip verification will now be described with respect to FIG. 5.

Referring now to FIG. 5, there is shown at 500 a circuit for generating a multi-bit DATAOUT signal at 508 which as will be described below provides verification of the output PLL clock signal of a PLL circuit such as PLL output clock signal 612 shown in FIG. 6. A KEEP_COUNTING signal 320, as previously described with respect to FIGS. 3 and 4, is coupled to the INCREMENT input of counter 502. A CLEAR_COUNTER signal 322, as previously described with respect to FIG. 3, is coupled to the RESET input of counter 502. The PLL output clock signal, such as signal 612 of FIG. 6, is used as a general purpose system clock signal for the integrated circuit device, and is coupled to the clock input (indicated by an upside-down V) of each individual circuit such as is shown at 510 of FIG. 5 (this system clock signal is also coupled to the upside-down V clock inputs of the various circuits shown in FIG. 3). The counter 502 counts clock pulses appearing on the clock input signal 510 when the INCREMENT control signal of the counter is active—in this particular embodiment when the KEEP_COUNTING control signal 320 is active. The count of the clock pulses is provided at the output of the counter 502, as DATAOUT signal 508. Thus, the DATAOUT signal 508 provides a count of the number of PLL output clock signals that occur during the time that the KEEP_COUNTING signal is active, for example the time during the positive going pulse 416 and the negative going pulse 418 shown in FIG. 4. This DATAOUT signal 508 can then be read by circuitry within the device itself, such as an embedded controller or microprocessor, to verify proper PLL operation by examining the DATAOUT signal 508. The frequency of this global clock signal may be calculated since the period of the externally provided JTAG clock is known, and thus the expected frequency of the PLL generated clock can be determined based upon this known external clock frequency.

In an alternate embodiment, scan ports of the counter 502 are used to pre-load the counter with a known value. If the DATAOUT of the counter maintains its preloaded value after the MEASURE_REQUEST control signal has been issued, this is an indicator that the PLL circuitry may be completely non-functional.

Thus, by use of an externally provided clock signal, in this instance a JTAG CLOCK signal or scan clock, in combination with on-chip PLL verification circuitry, it is possible for a device to itself determine whether its internally generated clock signal is operating properly.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for verifying an internally generated clock signal of a device, the device having an external clock signal coupled thereto, comprising steps of:
generating the internally generated clock signal by the device; and
using circuitry within the device in combination with the external clock signal to self-determine by the device whether the internally generated clock signal is clocking at a predetermined frequency within the device.

2. The method of claim 1, wherein the external clock signal is a scan clock used for testing the device.

3. The method of claim 1, wherein the external clock signal is used to generate at least one control signal that is applied to a counter that counts the internally generated clock signal.

4. The method of claim 3, wherein the at least one control signal is a count enable signal and a count clear signal.

5. An integrated circuit device, comprising:
an external clock input;
an internal clock generation circuit that generates an internal clock signal;
a count enable circuit for generating a count control signal responsive to an internal clock measure request signal; and
a counter for counting the internal clock signal when the count control signal is active.

6. The integrated circuit device of claim 5, wherein the count enable circuit is also responsive to signal transitions of an externally supplied clock signal coupled to the external clock input when generating the count control signal.

7. The integrated circuit device of claim 5, further comprising an edge detection circuit for detecting a signal transition on an externally supplied clock signal when coupled to the external clock input, and responsive thereto for generating an edge detect control signal.

8. The integrated circuit device of claim 5, wherein the counter is accessible to the device during runtime of the device.

9. The integrated circuit device of claim 7, wherein the count enable circuit is also responsive to the edge detect control signal when generating the count control signal.

10. An integrated circuit device having an internal phase-locked loop (PLL) circuit and a PLL verification circuit that verifies operation of the PLL circuit using an externally supplied clock signal.

11. The integrated circuit device of claim 10, wherein the externally supplied clock signal is a boundary scan clock signal used to test the integrated circuit device.
